(19) United States
(12) Patent Application Publication
(10) Pub. No.: US 2012/0037575 A1
(43) Pub. Date: Feb. 16, 2012

(54) MOTION CONTROL SYSTEM

(76) Inventor: Alex Wen, Alhambra, CA (US)

(21) Appl. No.: 13/182,424

(22) Filed: Jul. 13, 2011

Related U.S. Application Data
(60) Provisional application No. 61/363,968, filed on Jul. 13, 2010.

(51) Int. Cl. G03B 17/56; F16M 13/00

(52) U.S. Cl. 211/26; 211/162

(57) ABSTRACT

Embodiments of motion control apparatus and systems to provide improved special effects for filmmaking are disclosed. In one embodiment, a motion control system comprises a modular track assembly comprising a plurality of connectable segments. The track assembly is configured to direct a movable trolley assembly that employs a platform to mount filmmaking equipment. The trolley assembly includes a drive assembly that responds to remotely generated control signals to move the trolley assembly along the track assembly.

### RELATED APPLICATIONS

This application claims benefit of priority to Provisional U.S. Application No. 61/363,968, filed Jul. 13, 2010; the aforementioned priority application being incorporated by reference in its entirety.

### TECHNICAL FIELD

The disclosed embodiments relate to motion control systems for equipment, and more particularly to motorized camera mounts.

### BACKGROUND

Filmmaking often employs sophisticated motion control equipment to capture specialized video segments and/or still shots. Often included under the category of “special effects” equipment, the systems may involve electromechanical features to assist in orienting or moving a camera, light, boom (or other equipment) in a manner that's overly difficult to achieve manually. Successful special effects often rely on the flexibility and performance of motion control systems to achieve optimum results.

Conventional motion control systems employ generic dolly's or car mounts to capture images while in motion. Such constructions are often bulky, difficult to employ in remote locations and limited in camera orientation capability.

What is needed, and as of yet unavailable, is a lightweight motion control system that provides portability, stability, and precise control over motion control equipment.

### BRIEF DESCRIPTION OF THE DRAWINGS

Embodiments of the disclosure are illustrated by way of example, and not by way of limitation, in the figures of the accompanying drawings and in which like reference numerals refer to similar elements and in which:

FIG. 1A illustrates a partial side view of one embodiment of a track assembly in accordance with one embodiment;

FIG. 1B illustrates a transverse cross-sectional view of the track assembly of FIG. 1A;

FIG. 1C illustrates a perspective view of the track assembly of FIG. 1A, in an upright orientation;

FIG. 2A illustrates a perspective view of one embodiment of a trolley assembly;

FIG. 2B illustrates a side view of the trolley assembly of FIG. 2A;

FIG. 2C illustrates a front view of the trolley assembly of FIG. 2A;

FIG. 2D illustrates a top plan view of the trolley assembly of FIG. 2A;

FIG. 3A illustrates a transverse side view of a further embodiment of a track assembly with a trolley assembly in operation;

FIG. 3B illustrates a partial inline side view of the track assembly of FIG. 3A;

FIG. 3C illustrates an embodiment of tubing employed in the track assembly of FIG. 3A;

FIG. 3D shows a perspective view of the track assembly similar to FIG. 3A;

FIG. 4A illustrates an embodiment of a trolley assembly for use with the track assembly of FIG. 3A;

FIG. 4B illustrates a side view of the trolley assembly of FIG. 4A;

FIG. 4C illustrates a perspective view of the trolley assembly of FIG. 4A looking upwards from a lower orientation; and

FIG. 4D illustrates a top plan view of the trolley assembly of FIG. 4A.

### DETAILED DESCRIPTION

Embodiments of motion control apparatus and systems to provide improved special effects for filmmaking are disclosed. In one embodiment, a motion control system comprises a modular track assembly comprising a plurality of connectable segments. The track assembly is configured to direct a movable trolley assembly that employs a platform to mount filmmaking equipment. The trolley assembly includes a drive assembly that responds to remotely generated control signals to move the trolley assembly along the track assembly.

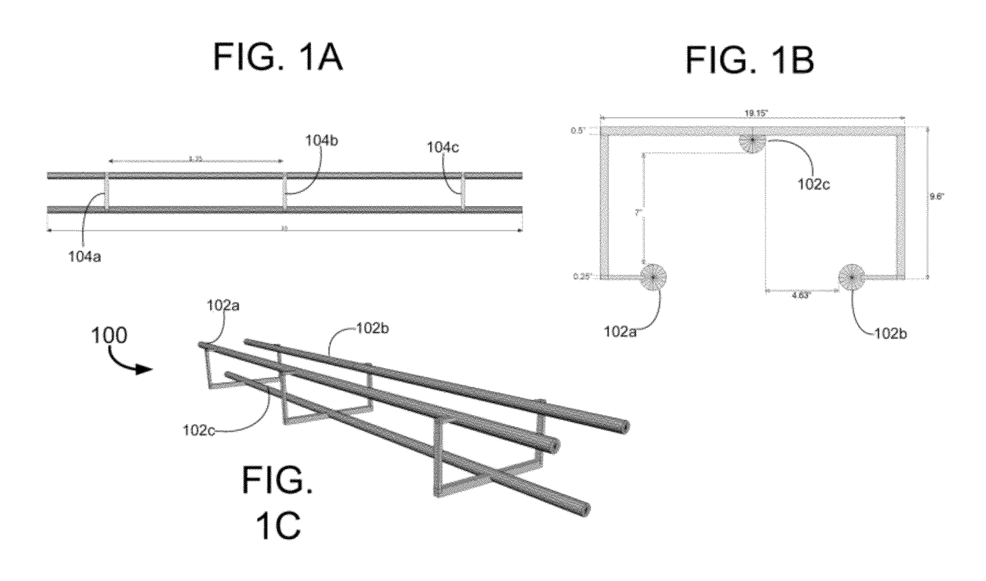

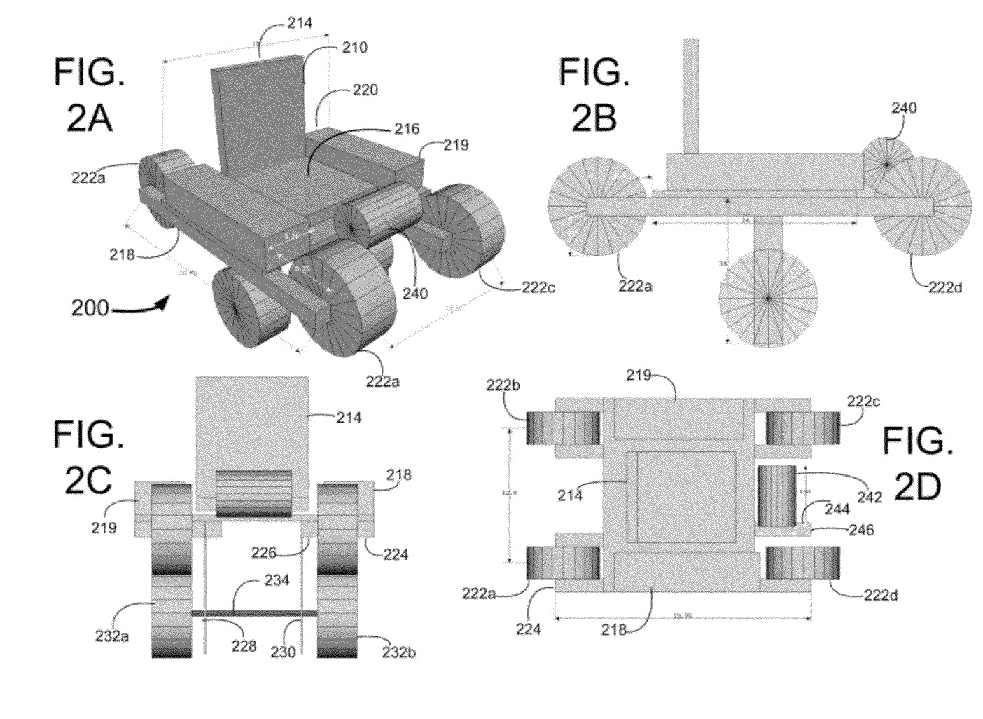

Referring now to FIGS. 1A-1C, a portion or segment of a track assembly is shown, generally designated 100, that employs a plurality of rails comprising metal tubular members 102a-102c. The tubular members are disposed longitudinally in a spaced-apart parallel relationship to provide a transport path for a trolley assembly (FIGS. 2A-2D). The relative spacing between a first pair 102a and 102b of the rails generally conforms to a corresponding trolley wheel spacing, while the third member 102c is offset (both vertically and horizontally) to effect a triangular cross-sectional shape with respect to the other two rails. A series of regularly spaced-apart U-shaped brackets 104a-104c are welded transversely to the rails to provide a support function and maintain the members in their relative parallel positions during transport of a trolley assembly. While the triangular configuration works well to minimize weight and materials, other arrangements may be used, including one or more additional rails to, for example, effect a rectangular configuration.

To achieve various track configurations, each segment of the track assembly 100 may employ connectors (not shown) at the ends of each rail to engage corresponding mating connectors formed on other segments. The connectors generally include respective male plugs (not shown) for engaging complementally formed female sockets (not shown) in a friction fit or quick disconnect manner. In one embodiment, segments join one way to minimize any risks of improper assembly. Other embodiments may employ universal segments that may join together in any desired orientation. Additional rigging in the form of support pillars (not shown) may be employed to provide even further support for the track assembly.

Further referring to FIGS. 1A-1C, the tubular members 102a-102c and brackets 104a-104C are formed from aluminum or stainless steel to provide a lightweight but strong structure. Other materials may also be employed that provide sufficient strength, rigidity, and portability to enable mobile set-up and tear-down operations. As described in further detail below, the lightweight segmented nature of the track 100 enables film crews to setup and operate trolley assemblies (described below) in a variety of remote and local environments.

Referring now to FIGS. 2A-2D, one embodiment of a trolley assembly is shown, generally designated 200, for operating along the track assembly 100 described above and shown in FIGS. 1A-1C. The trolley assembly 200 includes an equipment platform 210 that rests upon a movable frame assembly 220 that's powered by a drive assembly 240.

The equipment platform 210 comprises an L-shaped metal bracket including an optional rectangularly-formed vertical panel 214 joined at one end to a flat horizontally disposed seat 216. Respective elongated rectangular containers 218 and 219 are disposed on each side of the seat for housing power and control modules including a battery pack assembly and a wireless receiver assembly. The seat is adapted to mount equipment such as a movie camera, light, or the like, and may include one or more mounts, fasteners, or clamps to effect the mounting.

Further referring to FIGS. 2A-2D, the movable frame assembly 220 supports the equipment platform 210 and includes a first set of wheels 222a-222d to engage the upper surface of a track assembly (such as that disclosed in FIGS. 1A-1C). The first set of wheels is arranged in respective in-line pairs that are spaced-apart from each other in a manner that corresponds to the rail spacing of the track assembly. Respective horizontally disposed retaining rods 224 and 226 couple to each axle of each wheel to maintain wheel alignment and stability for each inline pair. The retaining rods 224 and 226 provide the support surface for mounting the equipment platform 210.

The frame assembly 220 further includes a pair of spaced-apart downwardly projecting vertical legs 228 and 230 that support a second set of wheels 232a and 232b coupled together by an axle 234. The second set of wheels are disposed in vertical alignment with each of the inline pairs of wheels 222a/222d and 222b/222c, and are offset vertically by a dimension sufficient for the second set of wheels to engage the bottom surface of the track tubular members 102a and 102b (FIG. 1C). The second set of wheels 232a and 232b provide additional adhesion to the track for applications where somewhat vertical or even inverted orientations may be employed that might otherwise tend to cause a derailing of the trolley assembly 200.

To effect maximum adhesion to the track rails 102a and 102b (FIG. 1C), all of the wheels are formed of a durable rubber or polyurethane material to maximize traction along the track assembly rails. Additionally, since each tubular member has a curvature associated with its surface, the engagement surface of each wheel is formed with a corresponding U-shaped curvature to complement the tubular member surface. The second set of wheels 232a and 232b and the associated legs 228 and 230 may be adjustable and/or pivotable to enable sufficient clearance for initially installing the trolley assembly 200 on the track assembly 100.

Further referring to FIGS. 2A-2D, the drive assembly 240 includes an electric motor 242 that is coupled to the power and control modules. The motor includes a rotating shaft (not shown) that mounts a first pulley 244. A belt 246 is looped over the first pulley and a second pulley (not shown) coupled to one of the wheels 222d to form a belt drive. The motor 242 responds to wireless control signals received by the wireless receiver assembly (not shown) to generate rotation of the shaft, and corresponding movement of the drive wheel 222d. A corresponding remote control (not shown) manipulated by a user provides the wireless input to the radio receiver. In one embodiment, to provide optimal control over a heavily-laden trolley assembly 200, a single wheel drive motor is employed. This provides optimal speed and torque in one direction. An exemplary motor runs on 36 volts DC, at a redline of 3000 RPMs, and draws 28.5 amps to dissipate 800 W. Other embodiments, such as those described below, employ multiple wireless channels, and may control the trolley bidirectionally and also control the velocity and acceleration of the trolley.

In operation, the track assembly 100 is first laid out by assembling sufficient segments into place such that the trolley assembly 200 may be guided in a manner that provides the desired motion control to effect, for example, an extreme filmmaking sequence. A key benefit of the system is enabling motion shots without exposing a live crewman to an extreme orientation or condition. Equipment such as a camera or light may then be mounted to the equipment platform 210 of the trolley assembly 200. With the trolley assembly secured to the track assembly 100, a user may manipulate the trolley forward while filming by actuating a switch or joystick on the remote control. Because of the belt-driven configuration of the trolley assembly 100, significant torque and speed may be achieved, depending on the application. This is especially beneficial for effects sequences employing heavy equipment, where horizontal transport on the order of 250 pounds or vertical transport of 100 pounds of equipment is desired.

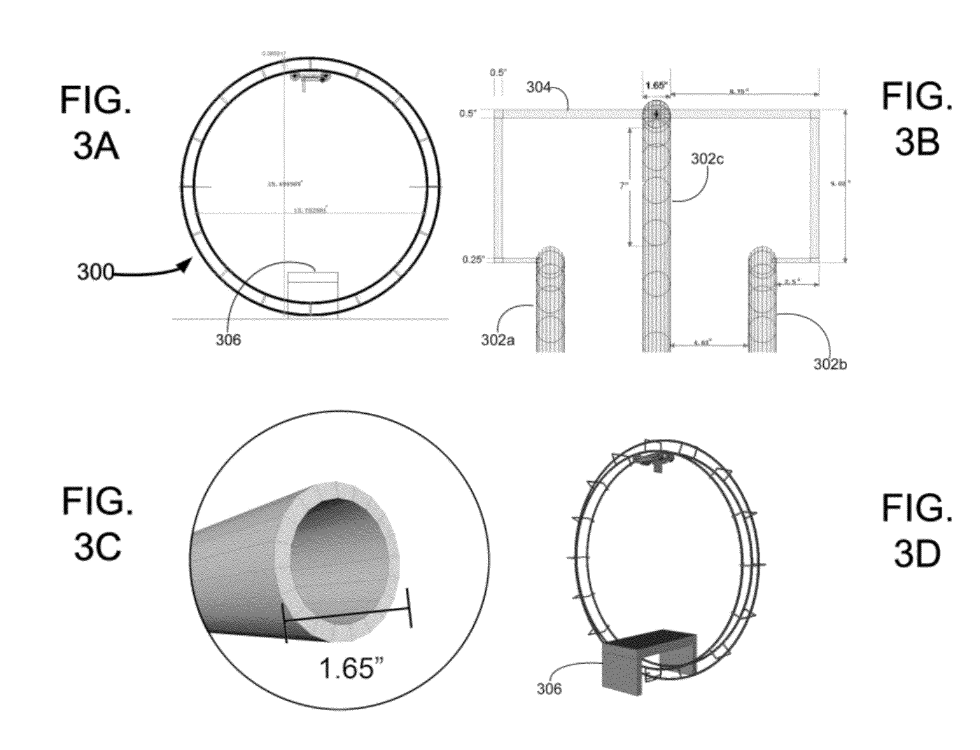

FIGS. 3A-3D illustrate an alternate embodiment of a track assembly, generally designated 300. The track assembly is similar to that shown in FIGS. 1A-1C, including a plurality of tubular rail members 302a-302c disposed in a spaced-apart parallel relationship, with regularly spaced support brackets 304. Respective segments may be formed with curvatures to, when assembled with a sufficient number of segments, form a completed track assembly taking on a circular configuration, as shown in FIGS. 3A and 3D. A stage 306 may optionally straddle a portion of the track to allow for movement of a trolley assembly at various surrounding orientations. Moreover, the circular track assembly may be oriented completely vertically, or at any desired angle (with sufficient bracing from auxiliary rigging attachments).

Although the track assembly embodiments of FIGS. 1A-1C and FIGS. 3A-3D are separately described herein as straight and circular tracks, various track layouts may benefit from mixed assemblies of straight and curved segments.

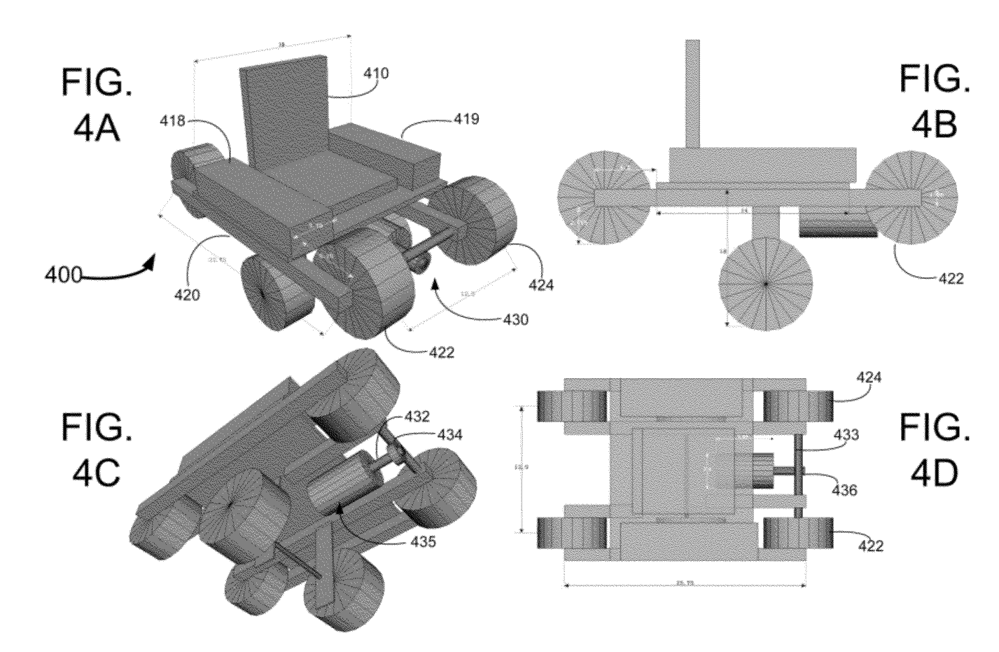

Referring now to FIGS. 4A-4D, a further embodiment of a trolley assembly, generally designated 400, is illustrated that provides bi-directional motion control. The trolley assembly includes an equipment platform 410 and frame assembly 420 constructed similar to that described in FIGS. 2A-2D. In one embodiment, a drive train assembly 430 is provided that employs an electric motor 435 responsive to a mufti-channel wireless radio (not shown). One of the channels provides for forward motion control, while another channel provides for reverse motion control. The bidirectional wireless control also enables near-instantaneous changes in direction, and speeds in the range of approximately 50 to 70 feet per second. An optional third channel may provide for speed control. The motor is a 48V DC motor that provides an output of 4 KW at a maximum speed of 2800 RPMs, and 13.6 Nm of torque. As in the prior embodiment, respective containers 418 and 419 disposed on each side of the equipment platform 410 house a power supply (in the form of a parallel array of batteries), and a wireless receiver control module.

To effect additional traction along a track assembly 300, the drive train assembly 400 implements a worm gear drive that allows for the direct drive and synchronization of two wheels 422 and 424. The worm gear drive includes a drive axle 432 that distally mounts a worm gear 434 for engaging a worm 436 formed on a common axle 433 joining the two wheels 422 and 424. Rotation of the drive axle 432 thus results in a corresponding rotation in the wheel axle 433, which translates to the two drive wheels to develop torque.

In a further embodiment, the electric motor may be replaced by a servo that incorporates built-in memory and control circuitry. One of the benefits realized by using a servo is the ability to carry out precise and repeatable trolley movements. Software resident on a general purpose computer may assist a user in programming the servo memory with a given sequence of desired servo movements, for subsequent execution in response to wireless control signals to carry out the sequence. In one embodiment, the software allows a user to operate the servo-driven trolley assembly 400 for a set duration (such as two minutes), record the sequencing of the servo controls, and provide a playback option so that the recorded sequence of movements can be repeated by the trolley assembly. The programmability provides for infinite repeatable exact programmable reference points, with an additional speed control feature. This is especially beneficial for applications involving heavy effects sequences, where the same camera can be controlled in a repetitive manner any number of times to capture the effect. Maximum speeds on the order of approximately 30 to 50 feet per second may be obtained. Moreover, the servo may be controlled at a high granularity such that fine-motion control over the trolley may be achievable. One embodiment provides a control granularity of approximately one wheel revolution per year. One example of a servo provides a maximum speed of 1500 RPM, with 990 oz-in of torque, at a peak power level of 515 Watts, and manufactured by Quicksilver (model QCI-34H-4-E-01).

Those skilled in the art will appreciate the many benefits and advantages afforded by the embodiments described herein. The portability and modularity of the track assembly allows for the use of the motion control system in a variety of filmmaking settings, both inside a studio setting and on-location outside of a studio setting. Moreover, by effecting a wireless control system for directing the trolley in one or more directions, extreme orientations for film sequences may be carried out in motion without exposing crewmen to the extreme conditions. Further, having a programmability aspect in some embodiments to achieve repeatability and precision simplifies the effects process for multiple sequences of similar shots.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

We claim:

1. A motion control system comprising:
a moveable trolley assembly including a platform;
a modular track assembly including a plurality of connectable segments, the track assembly configured to direct the trolley assembly; and
wherein the trolley assembly includes a drive assembly responsive to remotely-generated control signals to move the trolley assembly along the track assembly.

2. The motion control system of claim 1 wherein the platform is configured to mount filmmaking equipment.

3. The motion control system of claim 1 wherein the modular track assembly comprises:
a plurality of tubular members disposed longitudinally in a spaced-apart parallel relationship to provide a transport path for the trolley assembly.

4. The motion control system of claim 3 wherein the drive assembly includes a set of wheels disposed in a spaced-apart manner corresponding to the tubular member spaced-apart relationship.

5. The motion control system of claim 4 wherein the drive assembly includes:
a motor; and
respective power and control modules coupled to the motor.

6. The motion control system of claim 5 wherein the motor includes:
a wireless receiver responsive to wireless control signals to control the motor in driving the set of wheels.

7. The motion control system of claim 6 wherein the wireless receiver includes multiple wireless channels.

8. The motion control system of claim 6 wherein the wireless receiver controls the motor to drive the set of wheels bidirectionally.
